(19) United States
(12) Patent Application Publication
(10) Pub. No.: US 2015/0215166 A1
(43) Pub. Date: Jul. 30, 2015

(54) System For Dynamic Configuration And Adaptation For Networks And Services

(71) Applicant: CIPHERGRAPH NETWORKS PRIVATE LIMITED, Bangalore (IN)

(72) Inventors: Jitender Sharan, Bangalore (IN); Abhishek Kumar Shrivastava, Bangalore (IN); Arun Raguraman, Bangalore (IN)

(73) Assignee: CIPHERGRAPH NETWORKS PRIVATE LIMITED, Bangalore (IN)

(21) Appl. No.: 14/604,774

(22) Filed: Jan. 26, 2015

(30) Foreign Application Priority Data
Jan. 28, 2014 (IN) 358/CHE/2014

(51) Int. Cl. H04L 12/24; H04L 12/26

(52) U.S. Cl. CPC H04L 41/0816; H04L 43/0876

(57) ABSTRACT

The invention discloses a computer implemented network resource monitoring method in a network that comprises a service profiler which detects plurality of services hosted on host servers over the network, and creates the unique profiles for each of the plurality of detected services on a local service profiles database using a service profiles database. In case of any changes in the IT configuration of the detected service, the service profiler requests a profile assistant to change IT configuration, wherein the profile assistant compares profile presets and the local service profiles database to make the necessary changes.

### FIELD OF INVENTION

The present invention is generally related to a method and system for monitoring the configurations of services hosted on a network and is more particularly related to the providing end users seamless access to hosted services on a network by making automatic changes to the IT configurations related to hosted services.

### BACKGROUND

As a general practice, in a distributed computing environment, multiple services are hosted on different servers that are distributed across a network. These hosted services can be either located in a single geographical location or distributed across multiple geographies. Examples of such service are Mail Service, Directory Services, Network File Systems, etc. In order to provide the end users access to these services, various configuration changes are required to be made in the network. For example, firewall rules need to be added/modified/deleted and appropriate routes need to be added/deleted/modified. Further, these configuration changes need to be properly documented at a different location to enable traceability. During the movement of these services from one location to another, temporary loss in connectivity may occur for the duration when necessary changes in IT configuration take place. In the current scenario, such configuration changes are handled manually, thus making it difficult to ensure uninterrupted end user access to the hosted services. Although, there are a lot of IT monitoring applications, which can detect availability or non-availability of these services, these applications fail to automatically detect their presence elsewhere within the network. Hence, it is not possible to achieve a completely seamless experience for the end user during the transition of these hosted services.

Therefore, a system is required which can identify various types of hosted services on a computing platform in a distributed environment to enable automatic configuration changes to these hosted services and the networking/IT environment, required for these hosted services to function correctly and enable seamless access to the end users (called “hosted services” or simply “services” in this document).

### SUMMARY

The present invention describes a method and system for network resource monitoring and refactoring, which provides end users seamless access to hosted services within a distributed computing environment. The system identifies the IT configuration of multiple hosted services present within a network, and uses the IT configuration information to provide uninterrupted access to the hosted services in case of any change in the IT configuration.

In one embodiment of the invention, the system uses multiple mechanisms to detect the various kinds of hosted services within its network. A profile is created for each of the detected hosted service, using information from an external database and external inputs from an external IT admin, if required. The profile information and IT configuration is stored on a local database. The stored IT configuration is applied through various mechanisms such as modifying firewall configuration, changing DNS entries or making API calls to enable the service and access to the service.

In another embodiment of the invention, the system refactors the IT configuration by applying the stored profiles on the local database in case there is any change in the IT configuration, thus enabling uninterrupted end user access to the hosted services. The process of refactoring is defined as a process of changing a software system or code in a manner that only improves the software system internally, without making any alterations to the external behavior of the software system.

In yet another embodiment of the invention, the system regularly detects the hosted services within its network and makes relevant changes to the IT configuration after pre-defined time intervals. This enables the system to avoid any interruption for the end user to access any newly hosted services.

The summary is provided to give a brief idea of the invention. It will be apparent to a person skilled in the art that the invention embodiments and definitions described in the summary are not intended to be used as a means for limiting the scope of the invention.

### BRIEF DESCRIPTION OF THE DRAWINGS

FIG. 1 is a diagram depicting a distributed computing environment where a user interacts with a service hosted on a server within a communication network, according to one embodiment of the invention.

FIG. 2 illustrates the key components of a system for network resource monitoring according to one embodiment of the invention.

FIG. 3 illustrates the implementation steps for the application of the system for network resource monitoring according to one embodiment of the invention.

FIG. 4 illustrates an example case wherein the operation of the system for network resource monitoring and refactoring can be described.

### DETAILED DESCRIPTION

The embodiments described in this section with details, are provided merely to illustrate the principles of the invention. Various details are set forth for the purpose of explanation rather than limitation. However, it will be apparent to a person skilled in the art that the invention can be practiced without these details and the given embodiments should not be construed as limiting the scope of the invention. Some of the terms as used in the patent application have been described below without limiting the scope of the invention.

Definitions:

Server—A server is a physical computer (a computer hardware system) or a virtual machine (software implementation of a machine that executes programs like a physical machine) dedicated to running one or more services (as a host) to serve the needs of users of the other computers on the network. Depending on the computing service that it offers it could be a database server, file server, mail server, print server, web server, or any other computing server.

Computing Node: A device or system capable of processing/executing computing operations, with a layer of software or firmware to implement the computing logic that governs its functioning. A computing node may have auxiliary features like storage.

Client Computing Device: Computing node as a device used by an end-user of the system—could be either a mobile node or a fixed node. The device could be a computer, laptop, mobile phone or any other device that has capabilities to run and execute software codes.

Distributed System: A system consisting of multiple computing nodes connected by networks.

Cloud: A network of remote servers hosted on the Internet or any other network, which is used to store, manage, and process data remotely instead of using local servers or personal computers.

IT Configuration: IT Configuration is the complete set of configuration/s under the control and responsibility of an organisations' IT Department. In the document it refers to various parameters managed by the IT Department, such as Network Configuration, Directory Services, Software Inventory etc.

The embodiments are described below in order to explain the invention by referring to the figures.

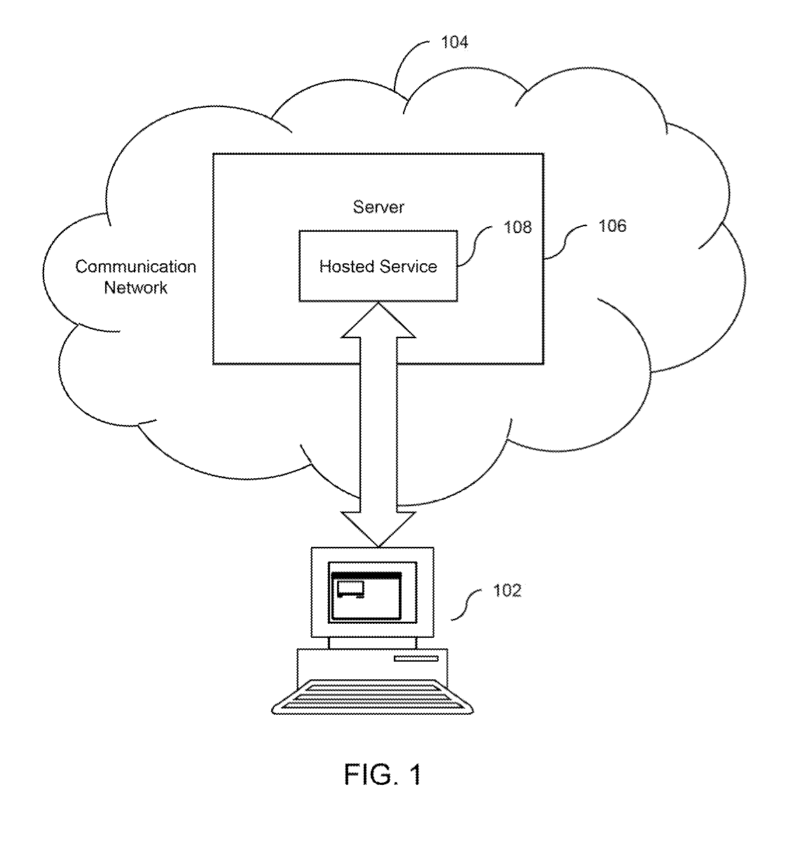

FIG. 1 is a diagram depicting an environment where the invention may be practiced, according to one embodiment of the invention. Illustratively, the environment comprises a client computing device 102 through which an end user can access a service hosted on a communication network 104. Examples of the client computing device 102 include but are not limited to laptops, personal desktop computers, mobile phones, Personal Digital Assistants (PDAs), iPads™, Tablets, Internet kiosks device or any other communication and processing device. The communication network 104 can be internet, mobile communication network, 2G, 3G, CDMA, GPRS, WLAN, LAN or any other form of communication network that makes the data transmission feasible between any two computing nodes.

According to one embodiment of the invention, an example of the distributed computing environment could be a datacenter. The datacenter comprises different servers accessible to multiple client computing devices 102. Each server within the datacenter has its unique network configuration. During the event of addition, deletion or movement of any server within the datacenter, the invention enables the datacenter to identify the configuration changes related to firewalls, DNS servers, directory servers, etc., and applies those changes to the communication network 104.

According to another embodiment, an example of the application of the invention is a scenario wherein an organization changes its distributed computing environment from a datacenter to a cloud. During the migration from the datacenter to the cloud, the invention enables the cloud to identify the IT configuration changes and applies these changes to the communication network 104. For example, if a network-operated service, such as SharePoint, is to be moved from the datacenter to the cloud, its servers need to be migrated to the cloud. During the migration, the invention identifies the changes in IT configuration related to firewalls, DNS servers, directory servers, etc., and applies those changes to the communication network 104.

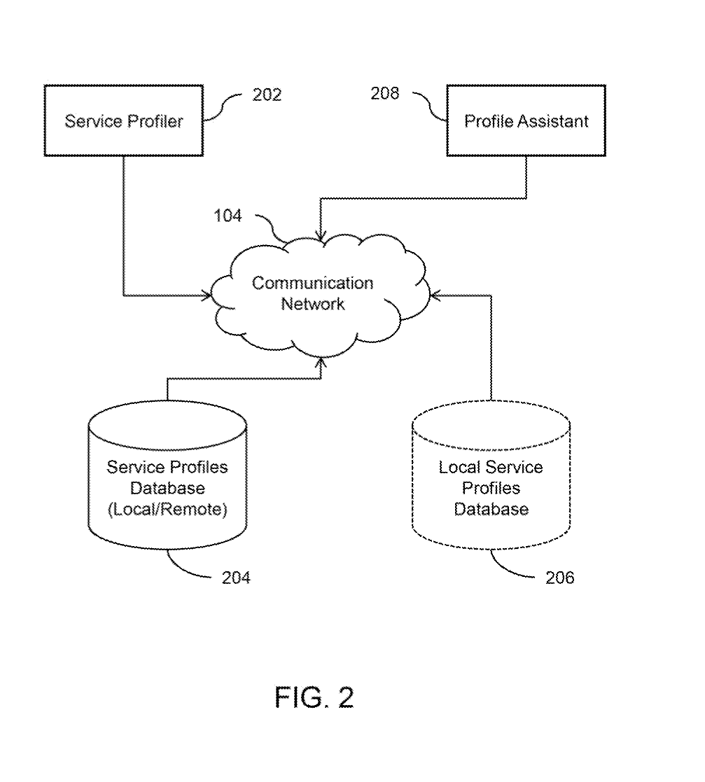

FIG. 2 shows the components of the system for a network resource monitoring and refactoring, referred to as the system, according to one embodiment of the invention. The system comprises a service profiler 202, a service profiles database 204, a local service profiles database 206, and a profile assistant 208 connected with each other through the communication network 104.

The role of the service profiler 202 is to detect the different type of hosted service by using various mechanisms. The service profiler 202 is also responsible for monitoring the communication network 104 for any changes in the IT configuration that may occur due to changes which include, but are not limited to, changes in server locations, and modifications to IP addresses, routing and DNS entries. The service profiler 202 detects the profiles of the hosted services using the service profiles database 204 and makes the necessary IT configuration changes using the profile assistant 208.

The service profiles database 204 is an opaque database which stores a set of pre-determined profiles/signatures of various well known services called profile presets. The profile presets enable the service profiler 202 to create a basic profile of a hosted service detected in the communication network 104 and enables the external IT admin to add further attributes if required. A record of the complete profile of the detected hosted service is stored in the local service profiles database 206 to enable modifications in the IT configuration of the hosted service in case of changes in the IT configuration within the distributed computing environment or the communication network 104. The local service profiles database 206 can be located in the same location as the service profiler 202 or can be located remotely.

The profile presets of the well-known hosted services contain very detailed information related to attributes such as, but not limited to, port numbers, Routing, DNS, Operating system Support, and dependency on other services. The profile presets also keep a track of the variations in the requirements for different versions of the hosted services.

The role of the profile assistant 208 is to make the necessary changes in the IT configuration of the communication network 104, based on the profile information of the hosted service, in order to provide uninterrupted access to the end user. The profile assistant uses various mechanisms to make these changes.

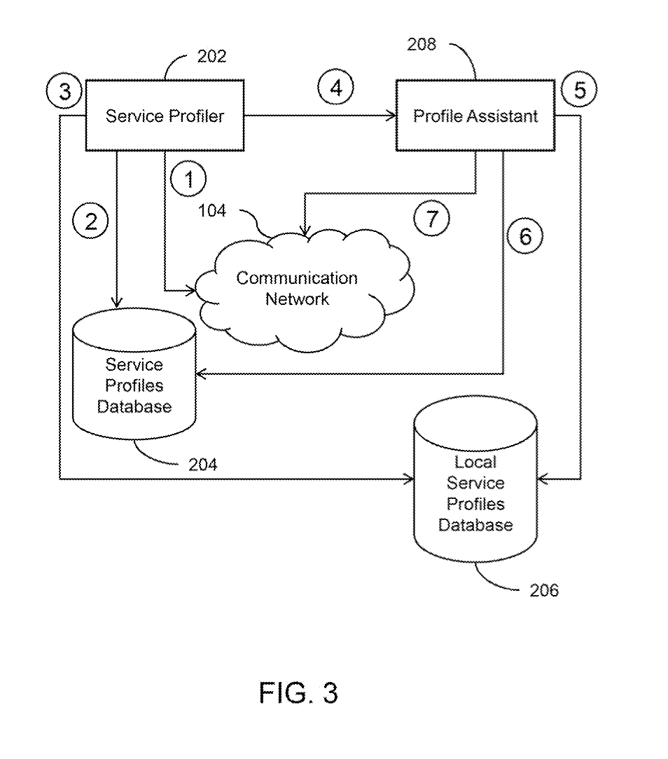

FIG. 3 illustrates the process of implementing the system for network resource monitoring and refactoring according to one embodiment of the invention.

In the first step, the service profiler 202 detects the various types of hosted services hosted on the communication network 104. According to one embodiment, the service profiler 202 uses network probing and port scanning to find the ports open on a server to enable a particular hosted service. For example, if ports 389, 636 are responding, ldap might be hosted on the communication network 104.

In another embodiment, the service profiler 202 detects the hosted services by parsing of responses to various types of requests for identification of version, capability and capacity of hosted services such as HTTP, HTTPS, FTP, SSH, RSH, LDAP, and SMB. Also, such responses can be used to identify the Server OS version and fetch its support matrix from a local database or a remote website or a remote database to enable proper configuration of the hosted service.

In another embodiment, the service profiler 202 presents the detected parameters such as open ports, running services, OS Version, Support Capabilities to the administrators to enable manual creation of such profiles.

In another embodiment, the service profiler 202 probes directory services to get the information about the hosted service such as DNS Entries, IP address, and ports needed.

In another embodiment, the service profiler 202 detects the hosted services by receiving the profile information from an agent installed on the same server as the service.

In another embodiment, the service profiler 202 makes API calls to the hosted service. Examples of API calls include, HTTP Request/Response, REST API, and other proprietary APIs. The service profiler 202 might also use API calls to the platform hosting the server in case of virtualized environments.

In yet another embodiment, the service profiler 202 passively listens on all the network communication between various clients and servers to create a profile of the servers and the hosted services.

In the second step, the service profiler 202 receives the profile presets from the service profiles database 204 and creates a unique profile of the detected hosted services. Thereafter, in the third step, the service profiler 202 stores the unique profiles of the detected hosted services, received from the service profiles database 204 into the local service profiles database 206. In the fourth step, the service profiler 202 sends a request to the profile assistant 208 to read the local service profiles database 206 and apply the changes to the IT configuration of the communication network 104.

Thereafter, in the fifth step, the profile assistant 208 reads the local service profiles database 206 for the changes that need to be made to the IT configuration. In this step, the profile assistant 208 compares the profile presets and the local service profiles database 206. In the sixth step, the profile assistant 208 reads the service profiles database 204 to generate the set of final IT configuration changes that need to be applied to the communication network 104. In the final step, the profile assistant 208 uses multiple mechanisms to send out requests to change the IT configuration of the communication network 104.

In one embodiment of the invention, the profile assistant 208 uses direct calls to the firewalls and gateways to make the necessary change in IT configuration of the communication network 104 to provide a seamless and uninterrupted end-user experience. Examples of this mechanism include but are not limited to opening ports in firewall, creating/deleting new routes, and creating/deleting DNS entries.

In another embodiment, the profile assistant 208 makes API calls to the platforms hosting the services, e.g., in a virtualized environment, it is a call to the virtualization platform to change the network settings.

In yet another embodiment, the profile assistant 208 sends out request for the IT configuration changes by prompting the admin to make the necessary changes to the networking configuration of the communication network 104 via email, SMS, etc.

According to an embodiment of the invention, the service profiler 202 keeps monitoring the network for any changes in the parameters pertaining to the hosted services such as IP address, location, version, and specific version requirements. If the service profiler 202 detects any changes in the hosted service, then the service profiler 202 modifies the local profile for that hosted service and re-applies the profiles to the IT configuration using the profile assistant 208. Thus, once a hosted service is uniquely identified within the communication network 104, changes to the hosted service are automatically detected by the service profiler 202 and the necessary changes are made to the IT configuration within the communication network 104.

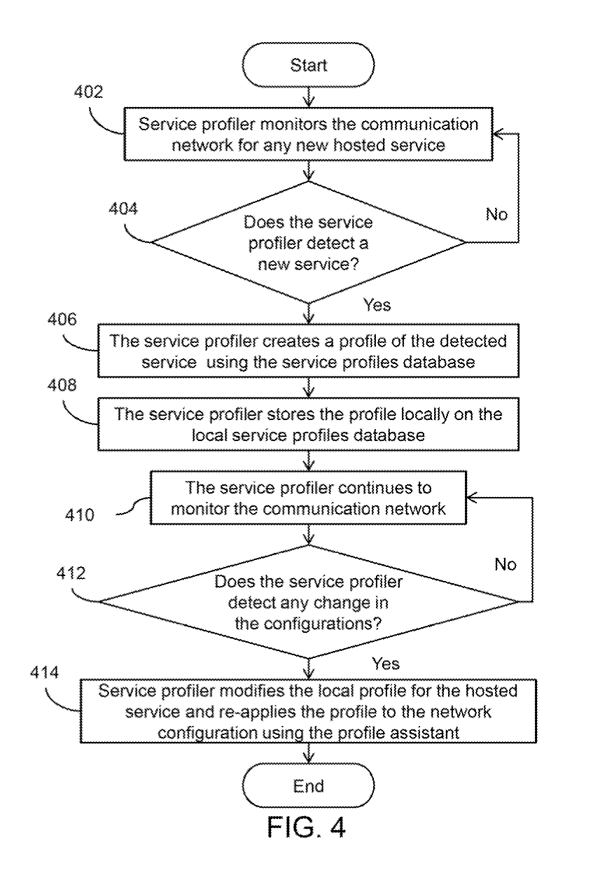

FIG. 4 illustrates an example case wherein the operation of the system for network resource monitoring and refactoring can be described.

In step 402, the service profiler 202 monitors the communication network 104 and tries to identify any new hosted service. As illustrated in step 406, if the service profiler 202 detects any new hosted service, it creates a profile of the detected hosted service using the service profiles database 204. Thereafter, in step 408, the service profiler 204 stores the profile locally on the local service profiles database 206. In an example depicting the application of the system, the service profiler 202 detects a hosted service running on port 21 on hardware HW1 with an IP address of IP1 within the communication network 104. The service is detected by the system as FTP and is confirmed by the admin. The service profiler 202 then creates the profile using the service profiles database 204 and further stores the profile locally on the local service profiles database 206.

In the next step 410, the service profiler 202 continues to monitor the communication network 104. If the service profiler 202 detects a change in the IT configurations of the detected service, the service profiler 202 modifies the local profile for the hosted service and re-applies the profile to the IT configuration using the profile assistant 208, as illustrated in step 414. For example, in continuation to the example of the detected FTP service running on port 21 on hardware HW1 with an IP address of IP1 within the communication network 104, if the service profiler 202 detects that HW1 is running with IP address IP2, the service profiler 202 then updates the profile for the FTP server and updates the firewall rules, routes, etc. to reflect the new IP address, thus ensuring that end user access to the FTP server is not interrupted. According to one embodiment, the service profiler 202 keeps monitoring the communication network 104 at pre-defined regular intervals.

The embodiments of the invention described above are intended for the purpose of illustration only. Numerous modifications, changes, variations, substitutions and equivalents will be apparent to those skilled in the art without departing from the spirit and scope of the invention as described in the claims.

What is claimed is:

1. A computer implemented network resource monitoring method in a network wherein the method comprising the steps of:
a) detecting plurality of services hosted on host servers over the network, wherein the services are detected by a service profiler;
b) updating unique profiles for each of the plurality of services detected, wherein the service profiler receives profile presets from a service profiles database, wherein the unique profiles created are stored in a local service profiles database;
c) requesting a profile assistant to change IT configuration by the service profiler;
d) analyzing the request to change the IT configuration, wherein the profile assistant compares the profile presets and the local service profiles database; and
e) enabling the changes in the IT configuration by the profile assistant.

2. The method step as claimed in claim 1, wherein the network is the Internet.

3. The method step as claimed in claim 1, wherein the service hosted on the host server is a network-based service.

4. The method step as claimed in claim 1, wherein the step of updating unique profiles for each of the plurality of services detected includes creating unique profiles for each of those plurality of services detected for which the unique profile does not exist in the local service profiles database.

5. The method step as claimed in claim 1, wherein plurality of services hosted on host servers over the network are detected by network probing, wherein the network probing identifies open ports on the host server that enable a particular web service.

6. The method step as claimed in claim 1, wherein plurality of services hosted on host servers over the network are detected by probe directory services to get the information about the hosted service including DNS entries, IP address and the ports required.

7. The method step as claimed in claim 1, wherein plurality of services hosted on host servers over the network are detected by making API Calls to the hosted service by the service profiler.

8. The method step as claimed in claim 1, wherein the profile assistant enables the changes in the IT configuration by making a direct call to the firewall gateway to make the changes in the IT configuration for a seamless and uninterrupted end-user experience.

9. The method step as claimed in claim 1, wherein the profile assistant enables the changes in the IT configuration by making API calls to platforms hosting the services.

10. The method step as claimed in claim 1, wherein the profile assistant enables the changes in the IT configuration by prompting the admin to make the changes in the IT configuration.

11. A system of computers for implemented network resource monitoring method in a network, wherein the method comprising the steps of:
a) detecting plurality of services hosted on host servers over the network, wherein the services are detected by a service profiler;
b) creating unique profiles for each of the plurality of services detected, wherein the service profiler receives profile presets from a service profiles database, wherein the unique profiles created are stored in a local service profiles database;
c) requesting a profile assistant to change IT configuration by the service profiler;
d) analyzing the request to change the IT configuration, wherein the profile assistant compares the profile presets and the local service profiles database; and
e) enabling the changes in the IT configuration by the profile assistant.

12. A computer implemented network resource monitoring method in a network wherein the method comprising the steps of:
a) detecting plurality of services hosted on host servers over the network, wherein the services are detected by a service profiler;
b) updating unique profiles for each of the plurality of services detected, wherein the service profiler receives profile presets from a service profiles database, wherein the unique profiles created are stored in a local service profiles database;
c) requesting a profile assistant to change IT configuration by the service profiler;
d) analyzing the request to change the IT configuration, wherein the profile assistant compares the profile presets and the local service profiles database; and
e) enabling the changes in the IT configuration by the profile assistant; and
f) repeating steps (i) to (v) after a pre-determined period of time.
